(19) United States
(12) Patent Application Publication
(10) Pub. No.: US 2004/0204914 A1
(43) Pub. Date: Oct. 14, 2004

(54) Method and apparatus for monitoring the provision of a utility

(76) Inventor: Robert John Milland, Wiley Park (AU)

Correspondence Address: LADAS & PARRY, 26 WEST 61ST STREET, NEW YORK, NY, 10023, US

(21) Appl. No.: 10/483,857

(22) PCT Filed: Jun. 7, 2002
(86) PCT No.: PCT/AU02/00748

(30) Foreign Application Priority Data
Aug. 13, 2001 (AU) PR 6962
Nov. 6, 2001 (AU) 2001100537

(51) Int. Cl. G06F 15/00

(52) U.S. Cl. 702/188

(57) ABSTRACT

A method of remotely monitoring the provision of a utility at a plurality of locations. The method comprises the steps of remotely interrogating control devices at their locations with each of the devices having a unique address. Each of the interrogated devices responds with a return signal which can be processed to obtain information concerning the usage of the utility at each of the locations.

### FIELD OF THE INVENTION

The present invention relates to a method of remotely monitoring the provision of at least one utility and to a control device which can be used to obtain information concerning the usage of at least one each utility.

### BACKGROUND OF THE INVENTION

Broadcasters and providers of pay TV services usually encode or encrypt their transmitted signals so that unauthorised customers should be unable to receive it. Only an authorised consumer is provided with a decoder that decodes the signal and therefore allows the consumer to access the broadcasted program.

Encoding and authorised decoding is therefore used to control the consumer reception of broadcasted signals and to avoid piracy. However, new methods to decode the broadcasted signal without authorisation have emerged and it is therefore desirable to develop a better method to monitor and control the reception of broadcasted signals by the consumer.

Further, the usage of consumables, such as water, gas and electricity that are being delivered to the consumer is associated with labour intense manual read-out of individual metering devices required to monitor the consumption. It would be desirable to develop a more efficient method to monitor the usage of such consumables.

### SUMMARY OF THE INVENTION

The invention provides in a first aspect a method of remotely monitoring the provision of at least one utility at one or more locations in substantially real-time, the utility being provided via a TV transmission line, the method comprising the steps of:

remotely interrogating at least one control device via the TV transmission line at at least one of the locations, the or each control device having a unique address; and

the or each interrogated control device, via the TV transmission line, responding with a return signal which can be processed to obtain substantially real-time information concerning the current usage of the or each utility at the or each location.

A second aspect of the invention provides a control device including an electronic circuit and being operatively coupled via a TV transmission line to at least one utility provided by the TV transmission line, the circuit having a unique address and comprising:

a receiving circuit being adapted to be remotely interrogated; and

a transmitting circuit being coupled to the receiving circuit and being adapted, on interrogation of the receiving circuit, to respond with a return signal which can be processed to obtain substantially real-time information concerning the current usage of the or each utility.

A third aspect of the invention provides a method of remotely monitoring the provision of at least one utility at one or more locations, the method comprising the steps of:

remotely interrogating at least one control device via a TV transmission line at at least one of the locations, the or each control device having a unique address; and

the or each interrogated control device, via the TV transmission line, responding with a return signal which can be processed to obtain information concerning the usage of the or each utility at the or each location.

Preferred Features of the Invention

In one embodiment of the present invention the or each utility relates to the broadcast of at least one TV signal via the TV transmission line. In this case processing the return signal may comprise identifying if the consumer associated with the address is authorised to receive the broadcasted signal. If the consumer is not authorised, the method may comprise the additional step of sending at least one blocking-signal to the address and thus blocking the consumer reception of the or each broadcasted TV signal. Processing the return signal may also comprise monitoring reception of the TV signal, for example for statistical purposes.

In another embodiment of the present invention the or each utility relates to access to the world-wide-web via the TV transmission line. In this case processing the return signal may comprise identifying if the consumer associated with the address is authorised to access the world-wide-web. If the consumer is not authorised, the method may comprise the additional step of sending at least one blocking-signal to the address and thus blocking the access to the world-wide-web. Processing the return signal may also comprise monitoring the access to the world-wide-web, for example for statistical purposes.

In an embodiment of the third aspect of the present invention the or each utility is a consumable such as water, gas, or electricity. In this case the step of responding may involve triggering at least one read-out of a metering device. The return signal preferably contains information concerning the read-out which may be processed to identify if the consumer associated with the address is authorised to receive the or each consumable. If the consumer is not authorised, the method may comprise the additional step of sending at least one blocking-signal to the electronic address and thus blocking the access to the or each consumable.

In am embodiment that relates to all aspects of the present invention the or each utility may also relate to medication or to a medical treatment. In this case the return signal may contain information concerning a patients health. If the health is not satisfactory, the method may comprise the additional step of sending at least one signal to a device at a respective one of the electronic addresses to regulate the provision of the medication or to effect the treatment. Alternatively or additionally, the method may comprise the step of sending at least one signal to a health service provider such as a hospital or may comprise sending a blocking signal to interrupt the provision of the medication.

Further, the or each utility may relate to a security service. The return signal preferably contains information concerning security of at least one of the locations. If the or each location is not secure, the method may comprise the additional step of sending an alarm-signal to the or each respective electronic address to trigger emission of at least one visible or audible alarm signal. Alternatively or additionally, the method may also comprise the step of sending an alarm signal to a security service provider or may comprise sending a blocking signal to the electronic address to interrupt the emission of the alarm signal in case of a false alarm.

The above-defined method may comprise the additional step of externally programming the control-device by a programmer associated with the provision of the or each utility.

Preferred embodiments of the invention will now be described, by way of example only, with reference to the accompanying drawing.

### BRIEF DESCRIPTION OF THE DRAWING

FIG. 1 shows an electronic block-diagram of a control device according to an embodiment of the present invention.

### DETAILED DESCRIPTION OF PREFERRED EMBODIMENTS

A method of remotely monitoring the provision of at least one utility is now described.

The providers of a service such as Pay TV utilise an electronic network between a broadcasting sender and a plurality of locations, in this example households, to provide the consumer with their service. In this embodiment each household is equipped with a control device that has a unique electronic address. The sender, which may be a master computer, may remotely interrogate one of the control devices by sending a signal, such as a Pay TV signal, to a particular electronic address. The control device which is interrogated then responds by sending a return signal to the master computer which subsequently processes the return signal in order to establish that the consumer associated with the electronic address is authorised to receive the Pay TV signal. An authorised consumer, for example, would be a subscriber of the Pay TV service. If the consumer is not authorised, the master computer may send a blocking signal to the particular electronic address and the control device would then block the transition of the Pay TV signal from the broadcaster to the TV of the consumer. The master computer may store all allocated electronic addresses together with Pay TV channels or frequencies the customers are authorised to receive. Processing the return signals therefore would provide information concerning authorised and unauthorised usage by the consumer. This method has the significant advantage that an unauthorised consumer would not receive an encoded signal which he can possibly decode in an unauthorised manner, but the signal would simply be blocked. Therefore, piracy may be largely reduced. Further, TV signal decoders, as currently used by consumers, are not required and therefore this method may be more cost efficient.

The method has been described in the context of Pay TV. However, it will be appreciated that the method has other applications that broadly relate to all areas of TV including interactive TV.

In another embodiment of the present invention the utility relates to access to the world-wide-web. The providers of a service such as access to the world-wide-web utilise an electronic network between the service provider and a plurality of locations, in this example households, to provide the consumer with access to the world wide web. In this embodiment each household is equipped with a control device that has a unique electronic address. The service provider remotely interrogates one of the control devices by sending a control signal to a particular electronic address. The control device which is interrogated then responds by sending a return signal to the service provider which subsequently processes the return signal in order to establish that the consumer associated with the electronic address is authorised to access the world-wide-web. An authorised consumer, for example, would be a subscriber of the world-wide-web service. If the consumer is not authorised, the service provider may send a blocking signal to the particular electronic address and the control device would then block the access to the world-wide-web. The service provider may store all allocated electronic addresses and access details of associate consumers in the computer. Processing the return signal therefore would provide information concerning authorised and unauthorised usage by the consumer.

In a further embodiment of the present invention the method of remotely monitoring the provision of at least one utility relates to monitoring the usage of consumables. Examples of such consumables are water, gas and electricity. A central system, such as a master computer, associated with the provider of the consumables may remotely interrogate a control device by sending a trigger signal to the control device installed at a particular household. In this example the reception of the trigger signal by the control device initiates the readout of a metering device. The metering device may be an analog device and it may be coupled with the control device through an ADDA converter. The interrogated control device may then send a signal to the master computer which contains information concerning the readout. The readout may be used for a variety of purposes. For example, it may be used to invoice the consumer or it may be used to control the usage of the consumable. If the consumer is not authorised to use the consumable, the master computer may send a blocking signal to the control device and the control device may block the access to the consumable.

In a further embodiment of the present invention the or each utility relates to medication or to medical treatment. In this case the return signal would contain information concerning a patients health. For example, a monitor may be arranged to monitor the patients health. A remote interrogation by a health monitor service provider may trigger the monitor to respond with the return signal. If the patients health is not satisfactory, a further signal will be sent and directed, for example, to the monitor. The monitor may subsequently send a signal to a regulator which may regulate the provision of medication during treatment of the patient. Alternatively or additionally the method may also comprise the step of sending a signal to a health service provider such as a hospital.

In yet another embodiment of the present invention the or each utility relates to security service. In this case the return signal would contain information concerning the security of a location. For example, a security monitor may be arranged to monitor the security of the location. A remote interrogation by a security monitor service provider may trigger the security monitor to respond with the return signal. If the location is not secure, a further signal will be sent which may effect the emission of an alarm signal. Alternatively or additionally the method may also comprise the step of sending a signal to a security service that may send security service officers to the location.

In all embodiments described above the method may involve programming the control device externally by a programmer associated with the provider of the or each utility.

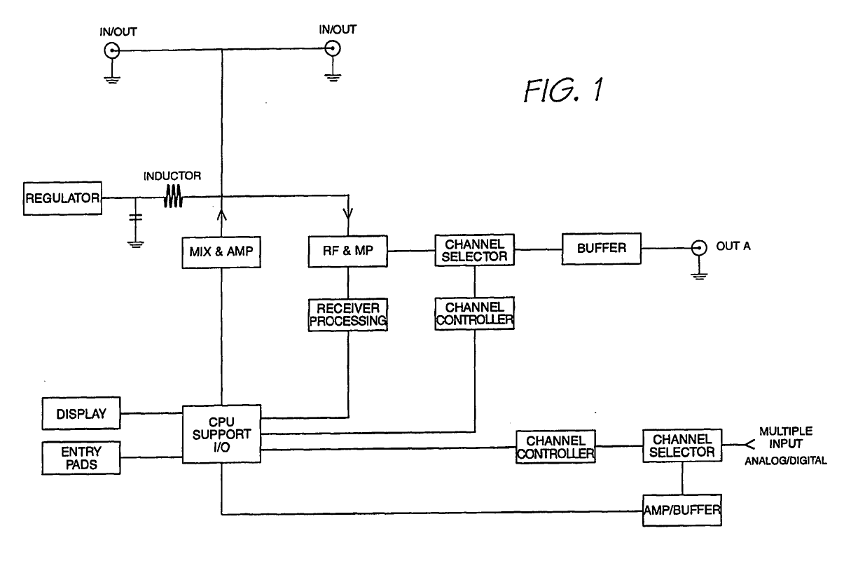

An embodiment of another aspect of the invention relating to a control device is now described with reference to FIG. 1. The control device comprises an electronic circuit and FIG. 1 shows an electronic block diagram of the circuit. When in use, the control device is being allocated a unique electronic address and the device is operatively coupled to at least one utility. For example, the circuit may be connected via a cable to a pay TV broadcaster or it may connected to gas, water, or electricity metering devices. The control device comprises a receiving circuit that is adapted to be remotely interrogated by receiving a signal from a sender such as a master computer. The device functions to respond to this interrogation by sending a return signal. The return signal may contain information concerning the usage of the utility. For example, if the device is operatively coupled to a gas, electricity or water meter, with the return signal may comprise a readout. If the control device is connected to a TV broadcaster, the control unit would function to send a return signal indicating that the consumer uses a particular TV channel and a master computer could process this information. In addition, the control device may function to block a signal or the access to the or each utility if a particular blocking signal has been received from the master computer.

Although the invention has been described with reference to particular examples, it will be appreciated by those skilled in the art that the invention may be embodied in many other forms. For example, the utility may relate to machinery in a factory and the return signal may provide information concerning the usage of machinery. The return signal may then be used to direct machinery via the control device.

In any of the above-described embodiments any of the signals, such as the return signal, may comprise video-signal information which may have been recorded with a video camera.

1. A method of remotely monitoring the provision of at least one utility at one or more locations in substantially real-time, the utility being provided via a TV transmission line, the method comprising the steps of:
remotely interrogating at least one control device via the TV transmission line at at least one of the locations, the or each control device having a unique address; and
the or each interrogated control device, via the TV transmission line, responding with a return signal which can be processed to obtain substantially real-time information concerning the current usage of the or each utility at the or each location.

2. The method as claimed in claim 1 wherein the or each utility relates to the broadcast of at least one TV signal via the TV transmission line and wherein the step of processing the return signal comprises identifying if the consumer associated with the address is authorised to receive the or each TV broadcasted signal.

3. The method as claimed in claim 2 comprising the additional step of sending at least one blocking-signal to the address and thus blocking the consumer reception of the or each TV broadcasted signal.

4. The method as claimed in claim 1 wherein the or each utility relates to access to the world-wide-web via the TV transmission line and wherein the step of processing the return signal comprises identifying if the consumer associated with the address is authorised to access the world-wide-web.

5. The method as claimed in claim 4 comprising the additional step of sending at least one blocking-signal to the address and thus blocking the consumer access the world wide web.

6. The method as claimed in claim 1 wherein the or each utility relates to medication or medical treatment and the return signal contains information concerning a patients health, the method comprising the additional step of sending at least one signal to a device at a respective one of the electronic addresses to regulate the provision of the medication or to effect the treatment.

7. The method as claimed in claim 1 wherein the or each utility relates to medication or medical treatment and the return signal contains information concerning a patients health, the method comprising the additional step of sending at least one signal to a health service provider such as a hospital.

8. The method as claimed in claim 1 wherein the or each utility relates to a security service, the return signal comprising information concerning security of at least one of the locations and the method comprising the additional step of sending an alarm-signal to the or each respective electronic address to trigger emission of a visible or audible alarm sound.

9. The method as claimed in claim 1 wherein the or each utility relates to a security service, the return signal comprising information concerning security of at least one of the locations and the method comprising the additional step of sending at least one alarm-signal to a security service provider.

10. The method as claimed in comprising the additional step of externally programming the control-device by a programmer associated with the provider of the or each utility.

11. The method as claimed in claim 1 wherein the return signal comprises video-signal information.

12. A control device including an electronic circuit and being operatively coupled via a TV transmission line to at least one utility provided by the TV transmission line, the circuit having a unique address and comprising:
a receiving circuit being adapted to be remotely interrogated; and
a transmitting circuit being coupled to the receiving circuit and being adapted, on interrogation of the receiving circuit, to respond with a return signal which can be processed to obtain substantially real-time information concerning the current usage of the or each utility.
